(19) United States
(12) Patent Application Publication
(10) Pub. No.: US 2015/0052112 A1
(43) Pub. Date: Feb. 19, 2015

(54) FILE SERVER, STORAGE APPARATUS, AND DATA MANAGEMENT METHOD

(71) Applicant: Hitachi, Ltd., Tokyo (JP)

(72) Inventors: Masahiro Shimizu, Tokyo (JP); Koji Honami, Tokyo (JP)

(73) Assignee: HITACHI, LTD., Tokyo (JP)

(21) Appl. No.: 14/241,730

(22) PCT Filed: Jan. 11, 2013
(86) PCT No.: PCT/JP2013/050447

§ 371 Date: Feb. 27, 2014

(51) Int. Cl. G06F 17/30

(52) U.S. Cl. CPC G06F 17/30156; G06F 17/30371
USPC 707/692

(57) ABSTRACT

A file server coupled to a client terminal via a network includes a storage unit for storing received files and a control unit for controlling writing or reading of the files to or from the storage unit, wherein the control unit: performs deduplication by deciding one of files with the same content, which are stored in the storage unit, as a clone source file, and deciding another file as a clone file, which refers to data of the clone source file; and appends data to the clone source file in accordance with an update instruction for the clone file from the client terminal.

### TECHNICAL FIELD

The present invention relates to a file server, a storage apparatus, and a data management method and is suited for use in a file server, storage apparatus, and data management method for executing deduplication processing by means of single instance.

### BACKGROUND ART

Conventionally, along with scale expansion and growing complexity of storage environment due to an increase of company data, thin provisioning utilizing virtual volumes which themselves have no storage area (hereinafter sometimes referred to and explained as the virtual volumes) has been being widespread for the purpose of easy operation management and integration of the storage environment.

Patent Literature 1 discloses a technique to create a clone, which is a writable copy of a parent virtual volume, as a virtual volume duplication technique. Specifically speaking, a snapshot of the parent virtual volume and a virtual volume which functions as a clone are created and update data for the snapshot is treated as another file (difference file), thereby managing differences. Immediately after this difference file is created, only a data block management table is created and a storage apparatus does not have physical data blocks. The data block management table stores, for example, a physical block number and an initial value is set to 0. Then, when a file regarding which 0 is stored in, for example, the physical block number in the data block management table is accessed, reference is made to snapshot data.

Furthermore, a storage apparatus has large-capacity storage areas in order to store large-scale data from a host system(s). Data from host systems have been continuously increasing every year. Because of problems of the size and cost of a storage apparatus(es), it is necessary to store large-scale data efficiently. So, attention has been focused on data deduplication processing for detecting and eliminating duplications of data in order to inhibit an increase of an amount of data stored in storage areas and enhance data capacity efficiency.

### CITATION LIST

### Patent Literature

[Patent Literature 1] U.S. Pat. No. 7,409,511

### SUMMARY OF INVENTION

### Problems to be Solved by the Invention

When a user updates data of a clone file by, for example, appending data according to the above-described Patent Literature 1, the appended update data is stored as a difference in the clone file. Regarding data of the clone file, the update data is managed as a difference file; and regarding data other than the update data, reference is made to data of the snapshot which is a source of the clone file. Accordingly, data of a file which is newly created by copying does not match the data of the clone source file. Accordingly, the copy source file for the clone file and a copied file seem to users to be files having the same data, but they actually have different data. Therefore, this results in a problem of inability to perform deduplication.

The present invention was devised in consideration of the above-described circumstances and aims at suggesting a file server, storage apparatus, and data management method capable of effectively deduplicating a copied clone file(s).

### Means for Solving the Problems

In order to solve the above-described problem, provided according to the present invention is a file server coupled to a client terminal via a network including: a storage unit for storing received files; and a control unit for controlling writing or reading of the files to or from the storage unit, wherein the control unit: performs deduplication by deciding one of files with the same content, which are stored in the storage unit, as a clone source file, and deciding another file as a clone file, which refers to data of the clone source file; and appends data to the clone source file in accordance with an update instruction for the clone file from the client terminal.

The above-described configuration is designed so that when data is to be appended to the clone file, the data is appended to not the clone file, but to the clone source file; and even when the clone file to which the data has been appended is copied, data of the clone source file matches data of the copied file. Accordingly, deduplication is performed even when the clone file with the appended data is copied. So, both flexibility of data changes and capacity efficiency by means of deduplication can be achieved.

### Advantageous Effects of Invention

According to the present invention, both flexibility of data changes and capacity efficiency by means of deduplication can be achieved by deduplicating a copied clone file(s) effectively.

### BRIEF DESCRIPTION OF DRAWINGS

FIG. 1 is a block diagram illustrating a hardware configuration of a computer system according to an embodiment of the present invention.

FIG. 2 is a block diagram illustrating a software configuration of a computer system according to the embodiment.

FIG. 3 is a conceptual diagram for explaining the outlines of single instance according to the embodiment.

FIG. 4 is a chart illustrating the content of an i-node management table according to the embodiment.

FIG. 5 is a conceptual diagram for explaining the single instance according to the embodiment.

FIG. 6 is a conceptual diagram for explaining processing for writing data to a clone file according to the embodiment.

FIG. 7 is a conceptual diagram for explaining processing for copying clone files according to the embodiment.

FIG. 8 is a flowchart illustrating deduplication processing according to the embodiment.

FIG. 9 is a flowchart illustrating file writing processing according to the embodiment.

FIG. 10 is a flowchart illustrating file reading processing according to the embodiment.

FIG. 11 is a flowchart illustrating file copy processing according to the embodiment.

### DESCRIPTION OF EMBODIMENTS

An embodiment of the present invention will be explained in detail with reference to the attached drawings.

### (1) Outlines of this Embodiment

Firstly, the outlines of this embodiment will be explained. An example of a deduplication function of a file system is a single instance function. When there are a plurality of files with identical data content in the file system having the single instance function, only one file is made to remain and other files refer to data of the remaining file. This single instance function makes it possible to reduce an amount of stored data and enhance capacity efficiency. One remaining file will be hereinafter referred to as the clone source file and another file will be referred to as the clone file in the following explanation.

Furthermore, when data of a clone file is updated by, for example, appending data, only the update data is retained as a difference in the clone file; and reference is made to the clone file with respect to the update data, while reference is made to the clone source file with respect to data which is not updated. In this way, the data can be updated in a state where duplicate data are eliminated.

When the above-mentioned clone file is copied under this circumstance, a file having the same data as the clone file is newly created as a normal file. If data of the clone file has not been updated, the data of the clone file matches data of the clone source file and deduplication is then performed. Then, the newly created file is formed into a clone file again.

However, if a user has updated the data of the clone file by, for example, appending data, the update data is stored as a difference in the clone file. So, data of the file newly created by copying does not match the data of the clone source file. Therefore, although the copy source file and the copied file seem to the user to be files having the same data, the file created by copying the clone file will not be deduplicated.

So, this embodiment is designed so that when data is to be appended to a clone file, the data is appended not to the clone file, but to its clone source file; and even when the clone file to which the data has been appended is copied, data of the clone source file matches data of a copied file. Consequently, the copy of the clone file with the appended data will also be deduplicated and both the flexibility of data changes and the capacity efficiency by deduplication can be achieved.

### (2) Hardware Configuration of Computer System

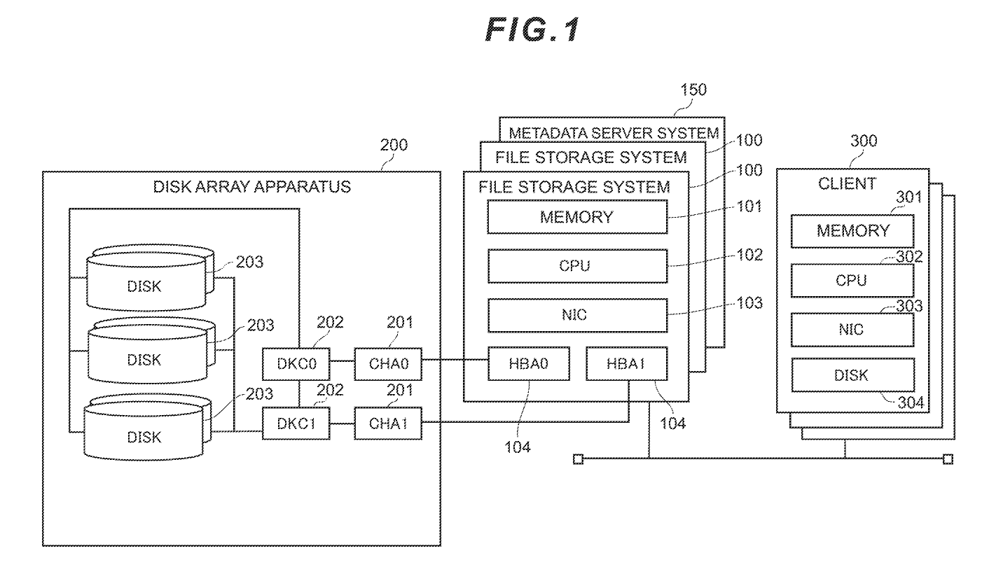

Next, a hardware configuration of a computer system will be explained. FIG. 1 is a block diagram illustrating the hardware configuration of the computer system. As depicted in FIG. 1, the computer system mainly includes a file storage system 100 providing files to a client 300, a metadata server system 150 for managing various metadata, and a disk array apparatus 200 for controlling, for example, writing of data to a plurality of hard disk drives (HDD).

In this embodiment, the file storage system 100 and the disk array apparatus 200 are configured as separate devices; however, the invention is not limited to this example and a storage apparatus may be configured by integrating the file storage system 100 with the disk array apparatus 200.

The file storage system 100 includes, for example, a memory 101, a CPU 102, a network interface card (indicated as NIC in the drawing) 103, and host bus adapters (indicated as HBA0 and HBA1 in the drawing) 104.

The CPU 102 functions as an arithmetic processing device and controls the operations of the file storage system 100 in accordance with, for example, programs and arithmetic parameters stored in the memory 101. The network interface card 103 is an interface to communicate with the client 300 and the disk array apparatus 200 via a network. Furthermore, the host bus adapter 104 connects the disk array apparatus 200 and the file storage system 100; and the file storage system 100 accesses the disk array apparatus 200 on a block basis via the host bus adapter 104.

The disk array apparatus 200 includes channel adapters (indicated as CHA0 and CHA1 in the drawing) 201, disk controllers (indicated as DKC0 and DKC1 in the drawing) 202, and a plurality of hard disk drives (indicated as DISK in the drawing) 203.

The channel adapter 201 for the disk array apparatus 200 receives an I/O request sent from the host bus adapter 104 for the file storage system and the disk array apparatus 200 selects an appropriate hard disk drive 203 from among the plurality of hard disk drives 203 via an interface under control of the disk controller 202.

The hard disk drives 203 is composed of semiconductor memories such as SSD's (Solid State Drives), expensive and high-performance disk devices such as SAS (Serial Attached SCSI) disks or FC (Fibre Channel) disks, and inexpensive and low-performance disk devices such as SATA (Serial AT Attachment) disks. The hard disk drives with the highest reliability and response performance among the above-mentioned types of the hard disk drives 203 are SSD's, the hard disk drives with the second highest reliability and response performance are SAS disks, and the hard disk drives with the lowest reliability and response performance are SATA disks. Furthermore, the plurality of hard disk drives are managed as one RAID group.

The client 300 includes, for example, a memory 301, a CPU 302, a network interface card (indicated as NIC in the drawing) 303, and a disk (indicated as DISK in the drawing) 304.

The client 300 reads programs such as an OS, which are stored in the disk 304 and control the client 300, to the memory 301 and has the CPU 302 execute the programs. Furthermore, the client 300 communicates with the file storage system 100, which is connected via the network, by using the network interface card 303 and executes access on a file basis.

### (3) Software Configuration of Computer System

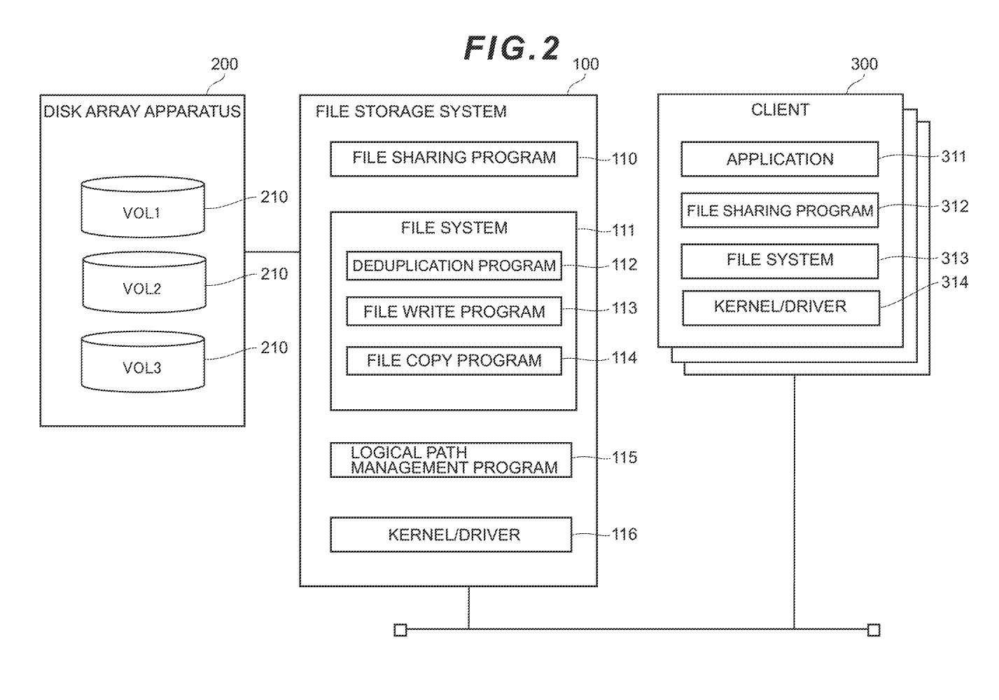

Next, a software configuration of the computer system will be explained. Firstly, the software configuration of the file storage system 100 will be explained. As depicted in FIG. 2, the memory 101 for the file storage system 100 stores a file sharing program 110, a file system 111, a logical path management program 115, and a kernel/driver 116.

The file sharing program 110 is a program for providing a file sharing system shared with the client 300 by using communication protocols such as a CIFS (Common Internet File System) and an NFS (Network File System).

The file system 111 is a program for managing a logical structure configured to realize management units, that is, files in volumes. Furthermore, a program for managing these files is called a file system program. A file system managed by the file system 111 is constituted from, for example, superblocks, an i-node management table, and data blocks.

The superblocks are areas in which information of the entire file system is retained collectively. The information of the entire file system includes, for example, the size of the file system and an unused capacity of the file system.

The i-node management table is a table for managing i-nodes associated with one directory and files. A directory entry including only directory information is used in order to access an i-node in which a file is stored. For example, when accessing a file defined as “home/user-01/a.txt,” the relevant data block is accessed by following the i-node number associated with the directory. Specifically speaking, the data block corresponding to the file can be accessed by following the i-node number in the order of, for example, “2→10→15→100.”

The i-node associated with the entity of the file stores information of, for example, the ownership, access right, file size, and data storage position of the file. Furthermore, this i-node is stored in the i-node management table. Specifically speaking, the i-node associated with only the directory stores the i-node number, update date and time, and i-node numbers of a parent directory and a child directory. Then, the i-node associated with the entity of the file stores, in addition to the i-node number, update date and time, and i-node numbers of the parent directory and the child directory, information such as an owner, an access right, a file size, and a data block address. The above-described i-node management table is a general table and the i-node management table according to this embodiment will be explained later in detail.

Furthermore, data blocks are blocks in which, for example, actual file data and management data are stored.

Furthermore, the file system 111 includes a deduplication program 112, a file write program 113, and a file copy program 114. The deduplication processing by the deduplication program 112, write processing and read processing by the file write program 113, and copy processing by the file copy program 114 will be explained later in detail.

The logical path management program 115 is a program for managing logical paths for accessing i-nodes where files are stored. Specifically speaking, the logical path management program 115 converts a file's logical path “home/user-01/a.txt” into a physical path “2→10→15→100.”

Furthermore, the kernel/driver 116 is a program for generally controlling the file storage system 100 and performing hardware-specific control by, for example, controlling schedules for a plurality of programs operating in file storage, controlling interrupts by hardware, and performing block-based inputs/outputs to/from storage devices.

Next, the software configuration of the disk array apparatus 200 will be explained. A memory (not shown in the drawing) for the disk array apparatus 200 stores a microprogram. The channel adapter 201 for the microprogram receives an I/O request sent from the host bus adapter 104 for the file storage system 100 and the microprogram selects an appropriate hard disk drive 203 from among a plurality of hard disk drives 203 via an interface under control of the disk controller 202 and executes I/O processing. The plurality of hard disk drives 203 are managed as one RAID group and one LDEV is created by cutting out some areas of the RAID group and is provided as an LU (logical volume) to the client 300 connected to the disk array apparatus 200.

Furthermore, a memory (not shown in the drawing) for the client 300 stores an application 311, a file sharing program 312, a file system 313, and a kernel/driver 314. The application 311 is a program for executing specified processing, for example, as input by a user. Since the file sharing program 312, the file system 313 and the kernel/driver 314 are the same as the file sharing program 110, the file system 111, and the kernel/driver 116 for the file storage system 100, any detailed explanation about them has been omitted.

### (4) Outlines of Processing by Computer System

### (4-1) General Single Instance

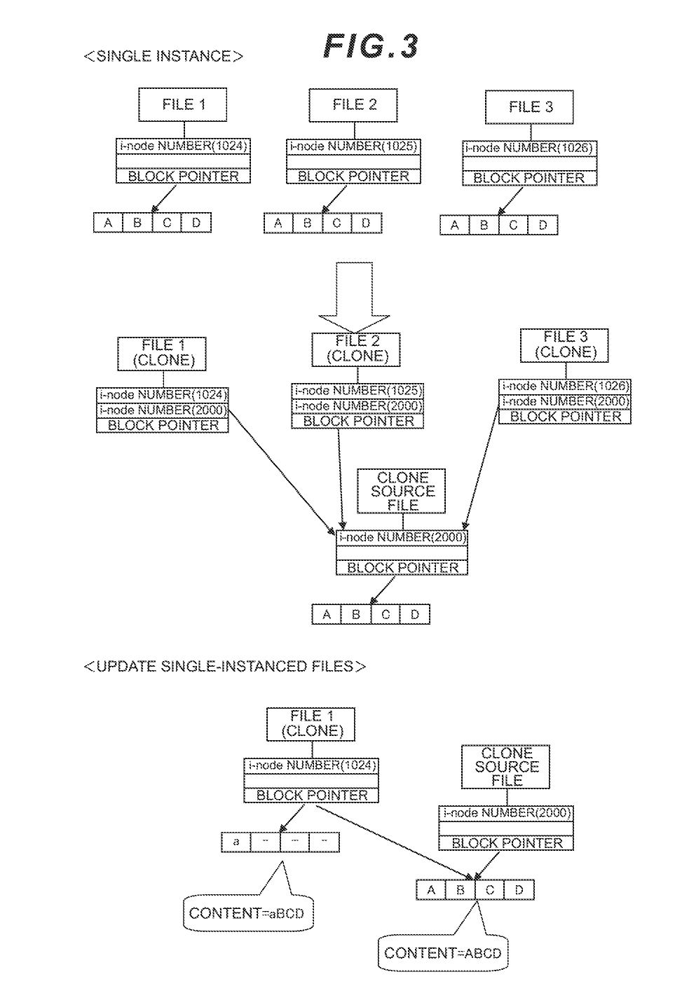

Next, general single instance will be explained with reference to FIG. 3. The single instance is a data deduplication function as mentioned earlier; and when a plurality of files whose entire file data content is completely identical exist, the single instance is the function that makes one of the files remain and replaces other files with reference to the remaining file with the file data.

As depicted in FIG. 3, the entire data content of file 1, file 2, and file 3 is ABCD, which is identical to each other. The data content of these three files matches the data content ABCD of an already single-instanced clone source file with i-node number 2000. Therefore, the data of file 1, file 2, and file 3 are deleted and a reference location of the data is set to the i-node number 2000 of the clone source file, so that the three files, that is, file 1, file 2, and file 3 are single-instanced and become clone files.

Furthermore, when the single-instanced file is to be updated, only the difference of updated data for the single-instanced file is stored as data of that file. For example, if data A of the pre-update data ABCD is updated to data a, only the updated data a is stored as data of the clone file and reference is made to the clone source file with respect to other data BCD.

On the other hand, when data is appended to the single-instanced clone file and the resultant data is copied, a problem of inability to perform the deduplication occurs. Specifically speaking, when the clone file in which data E is appended to the pre-update data ABCD is copied, the data content ABODE of this copy file does not match the data content ABCD of the clone source file. Therefore, although the clone file to which the data is appended and the copy file seem to the user to be files having the same data, the data content of the copy file does not match that of the clone source file. As a result, the copy file will not be single-instanced as a clone file of the clone source file.

So, this embodiment is configured so that when data is to be appended to a clone file, the data is appended not to the clone file, but to the clone source file; and even if the clone file to which the data has been appended is copied, data of the clone source file matches data of the copied file. In order to implement this deduplication processing, the file size of the clone source file when cloning is performed is stored, in addition to the current file size, in the i-node management table explained earlier in this embodiment.

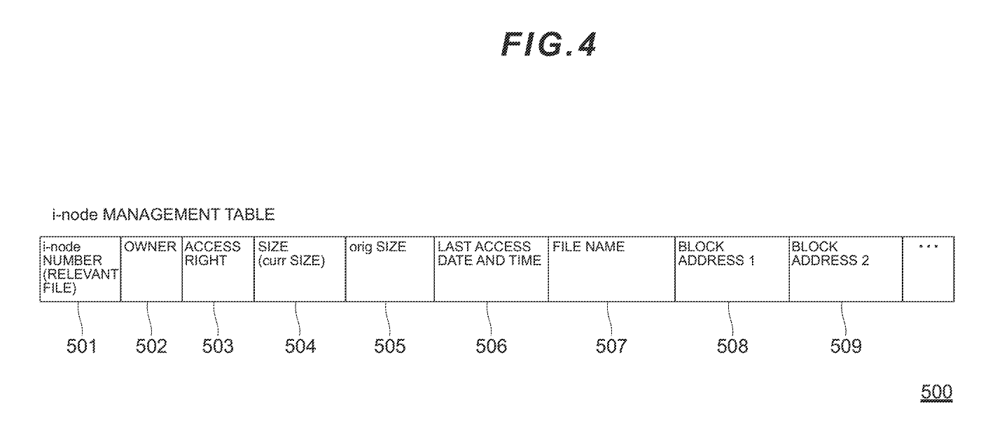

Specifically speaking, the current file size (curr size) 504 and the file size (orig size) 505 at the time of cloning are set to the i-node management table 500 as depicted in FIG. 4. Incidentally, the current file size is always set to the orig size of a clone file and a normal file in the i-node management table 500.

Then, when executing the deduplication processing, not only the content of the file data, but also the file sizes are compared. Specifically speaking, the comparison is performed to see if the current file size of a normal file matches either the current file size of the clone source file, which is to be compared, or the file size of the clone source file at the time of cloning. As a result, the data content of a file to which data has been appended can be compared by using the file size after appending the data; and the data content of a file to which no data is appended can be compared by using the file size before appending the data.

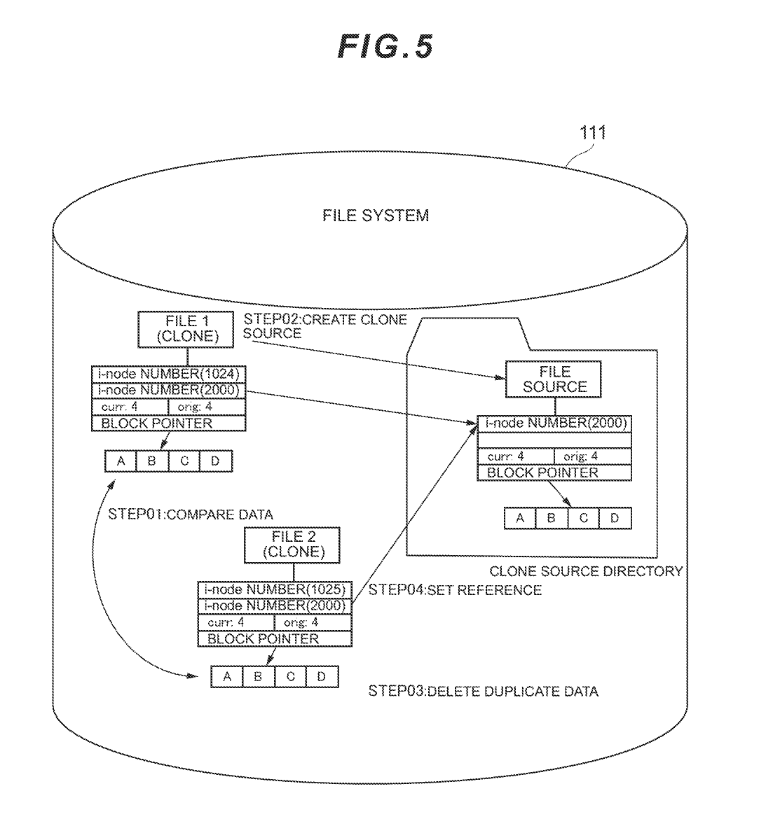

Next, the single instance according to this embodiment will be explained with reference to FIG. 5. The single instance is executed periodically according to a policy decided by the user or at certain intervals.

(4-2) Single Instance According to this Embodiment

As depicted in FIG. 5, firstly, data ABCD of file 1 is compared with data ABCD of file 2 (STEP 01). Since both the data of file 1 and the data of file 2 are the same content, that is, ABCD, the data of file 1 is copied as a clone source file to a clone source directory (STEP 02).

Furthermore, a redundant data block(s) of the clone file is deleted (STEP 03) and processing for setting reference from the duplicate clone file to the clone source file which is copied in the clone source directory is executed (STEP 04). Specifically speaking, upon the file reference setting in STEP 04, the i-node number 2000 of the clone source file is set as the i-node number of file 1 and file 2 which are clone files. As a result, reference is made to the data of the clone source file as the data of the clone file.

Furthermore, when the single instance of a file is performed in this embodiment as described above, the curr size (current file size) and the orig size (file size at the time of cloning) are stored in the i-node management table. Immediately after the single instance, the current file size is stored as the curr size and the orig size.

(4-3) Clone File Writing Processing According to this Embodiment

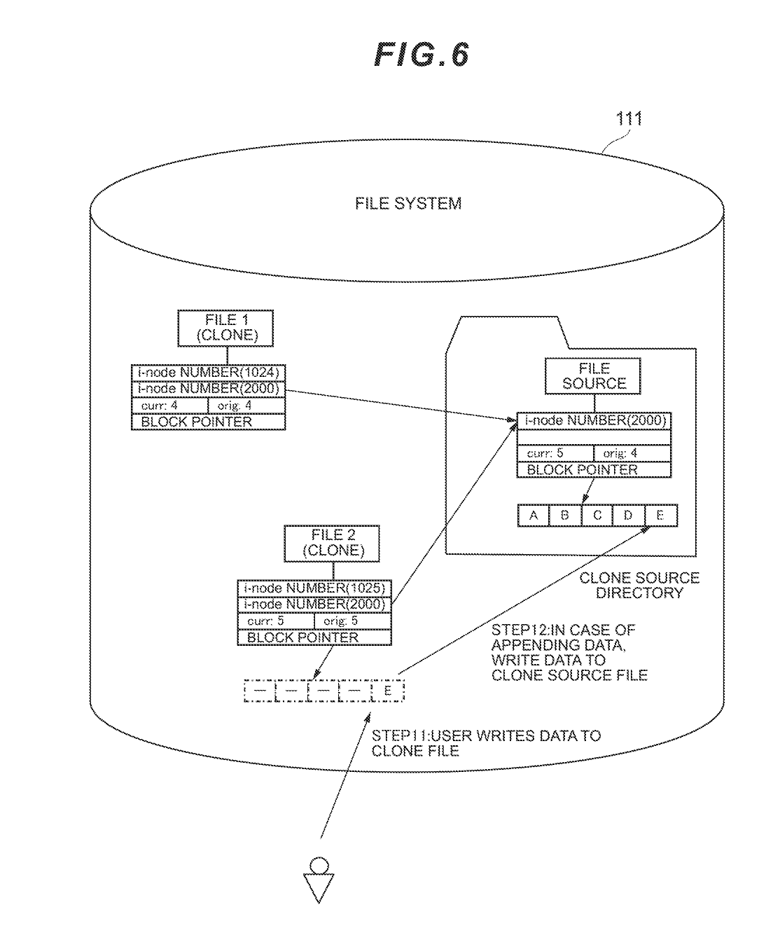

As depicted in FIG. 6, the user firstly writes data to a clone file (STEP 11). It is assumed in data writing in STEP 11 that a data update is an update including appending data.

If the update in STEP 11 is an update including appending data, the appended data is written to the data of the clone source file (STEP 12). In STEP 12, the appended data is written to the data of the clone source file and the curr size is changed from 4 before the update to 5 after the update.

(4-4) Clone File Copy Processing According to this Embodiment

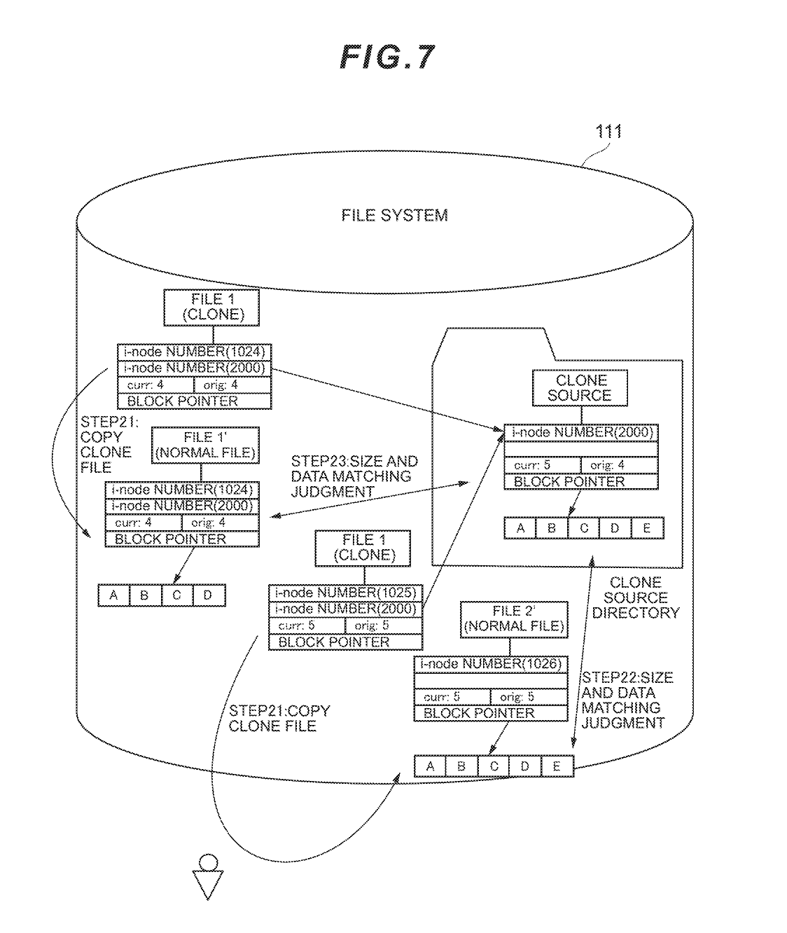

As depicted in FIG. 7, the user firstly copies the clone file for clone file copy processing (STEP 21). The clone file copy processing in STEP 21 is executed by combining processing for reading data from the clone file and writing the read data to a new file. Referring to FIG. 7, the deduplication processing is executed by deciding file 2′, to which file 2, the clone file, is copied, as a normal file.

After the clone file is copied in STEP 21, processing for judging whether data of the copied file 2′ matches the data of the clone source directory is executed. Specifically speaking, the data match judgment processing is to judge whether either the curr sizes or the orig sizes of these pieces of data are identical to each other; and if the sizes are identical, whether the data content is identical or not is judged. Then, since the data of the clone source file matches the data of file 2′, file 2′ is single-instanced and becomes a clone file.

### (5) Details of Data Management Method in Computer System

Next, the details of processing by each program will be explained. The above-described single instance is executed periodically by the deduplication program 112. Furthermore, the file writing processing is executed by the file write program 113 as input by the user. Furthermore, the file copy processing is executed by the file copy program 114, while file reading or writing processing associated with the file copy processing is executed by the file write program 113.

### (5-1) Deduplication Processing

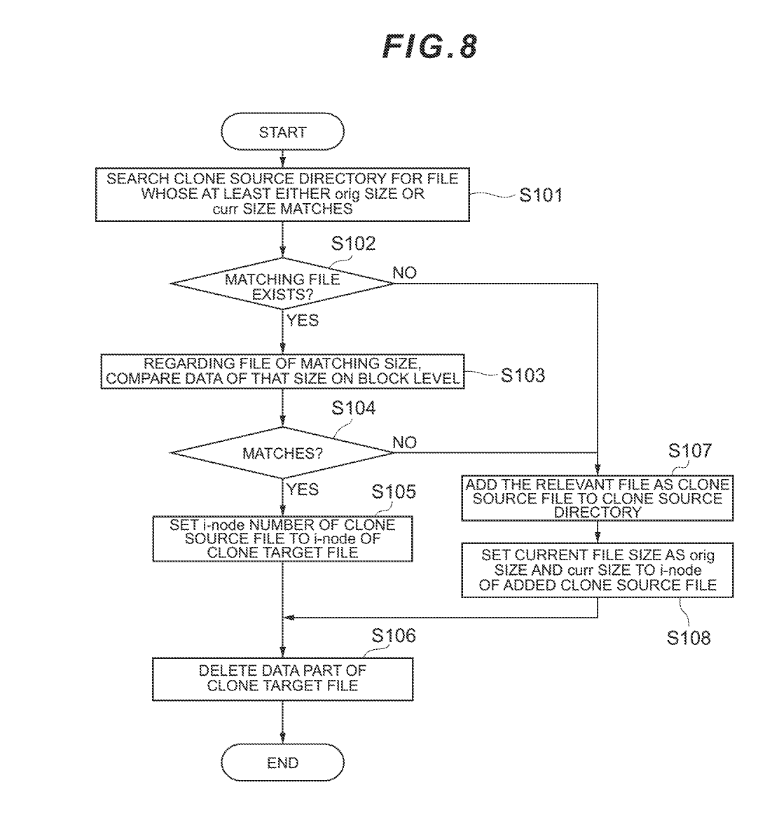

Firstly, the details of the deduplication processing by the deduplication program 112 will be explained. As depicted in FIG. 8, the deduplication program 112 searches the clone source directory for a file whose file size matches at least either the file size at the time of cloning (orig size) or the current file size (curr size) of a target file of the deduplication processing (S101).

The current file size is set to the curr size and the file size at the time of cloning is set to the orig size as described earlier. For example, when an update including appending data is executed on a clone file, the data is appended to the clone source file and the file size after the data update is set to the curr size.

Then, the deduplication program 112 judges whether or not any file whose file size matches the orig size or the curr size exists in the clone source directory (S102).

If it is determined in step S102 that a file of the matching file size exists, the deduplication program 112 executes processing in step S103. On the other hand, if it is determined in step S102 that a file of the matching file size does not exist, the deduplication program 112 executes processing in step S107 and subsequent steps.

In step S103, the deduplication program 112 compares the content of the data of the relevant size on a block level with respect to the files of the matching file size (S103). Before comparing the data content in step S103, the deduplication program 112 may calculate hash values of the files of the matching file size, compare the hash values, and then compare the data content.

Then, the deduplication program 112 judges whether or not the data content of the file matches the data content of the file in the clone source directory (S104).

If it is determined in step S104 that the data content of the files is identical, the deduplication program 112 sets the i-node number of the clone source file to the i-node of the clone target file (S105). As a result of the setting of the i-node number in step S105, a data reference location of the clone target file becomes a data storage location of the clone source file.

Then, the deduplication program 112 deletes a data part of the clone target file (S106). In this way, with respect to the file whose entire data content matches that of the clone source file, the single instance is executed by setting the reference location of that file to the clone source file and deleting the data of the target file.

Furthermore, if a file of the matching file size does not exist (No in S102) or if the file sizes are identical, but the data content is not identical (No in S104), the relevant file is added as a clone source file to the clone source directory (S107). Then, the current file size is set as the orig size and the curr size in the i-node of the clone source file added in step S107 (S108).

### (5-2) File Writing Processing

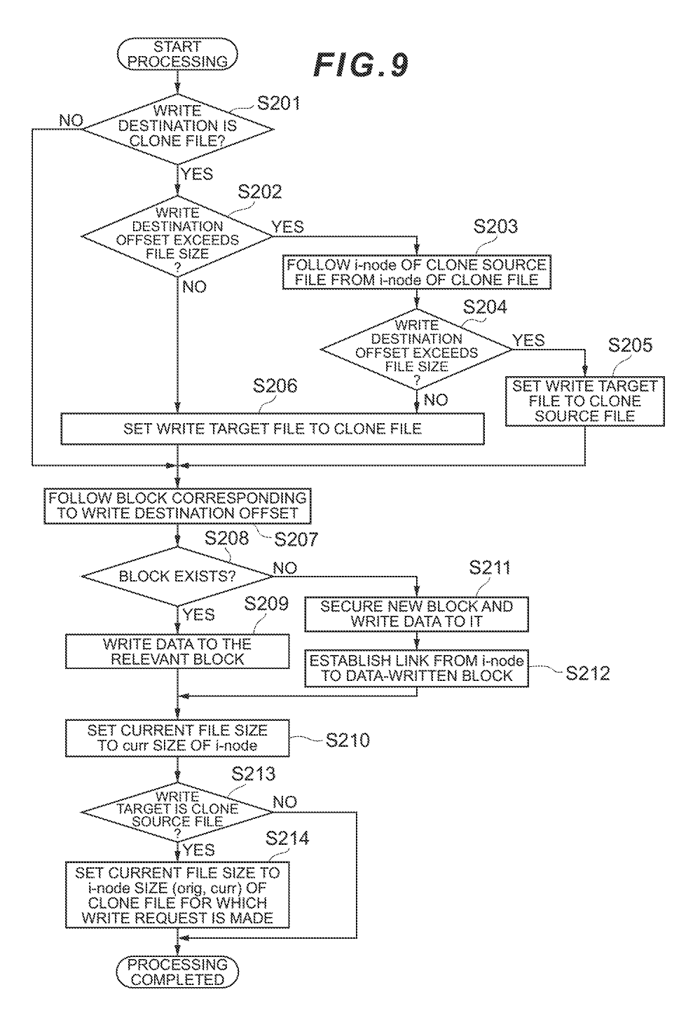

As depicted in FIG. 9, the file write program 113 judges whether a file which is a write location is a clone file or not (S201). If it is determined in step S201 that the write location file is not a clone file, processing in step S207 and subsequent steps is executed.

On the other hand, if it is determined in step S201 that the write location file is a clone file, the file write program 113 judges whether an offset of the write location exceeds the file size or not (S202). The case where the offset of the write location exceeds the file size in step S202 means that data is appended to the write location file.

If it is determined in step S202 that the offset of the write location does not exceed the file size, the file write program 113 executes processing in step S206 and subsequent steps.

On the other hand, if it is determined in step S202 that the offset of the write location exceeds the file size, the file write program 113 follows the i-node of the clone source file from the i-node of the clone file (S203) and judges whether the offset of the write location exceeds the file size or not (S204). In step S204, the file size of the clone source file for the write location is compared with the file size of the write target file.

Then, if it is determined in step S204 that the offset of the write location exceeds the file size, the file write program 113 sets the write target file as a clone source file (S205). This is because if the offset of the write location exceeds the file size and the appended data is written to the clone file, there is a possibility that the data of the clone source file may be overwritten by the aforementioned deduplication processing.

On the other hand, if it is determined in step S204 that the offset of the write location does not exceed the file size, the file write program 113 sets the write target file as a clone file (S206).

Then, the file write program 113 follows a block corresponding to the offset of the write location (S207).

If it is determined in step S207 as a result of following the block corresponding to the offset of the write location that there is a block corresponding to the offset of the write location, the file write program 113 writes data to the block found by following the block corresponding to the offset of the write location (S209).

On the other hand, if it is determined in step S207 as a result of following the block corresponding to the offset of the write location that there is no block for the write location, the file write program 113 newly secures a block and writes the data to that block (S211). Then, the file write program 113 establishes a link to the block, to which the data was written in step S211, from the i-node (S212).

Then, the file write program 113 sets the file size after writing the data in step S209 as the current file size to the curr size in the i-node management table 500 (S210).

Furthermore, the file write program 113 judges whether or not the write target is a clone source file (S213); and if the write target is the clone source file, the current file size is set as the size (the orig size and the curr size) in the i-node of the clone file for which the write request was made (S214), and then the file write program 113 terminates the write processing. On the other hand, if it is determined in step S213 that the write target is not a clone source file, the file write program 113 terminates the write processing.

### (5-3) File Reading Processing

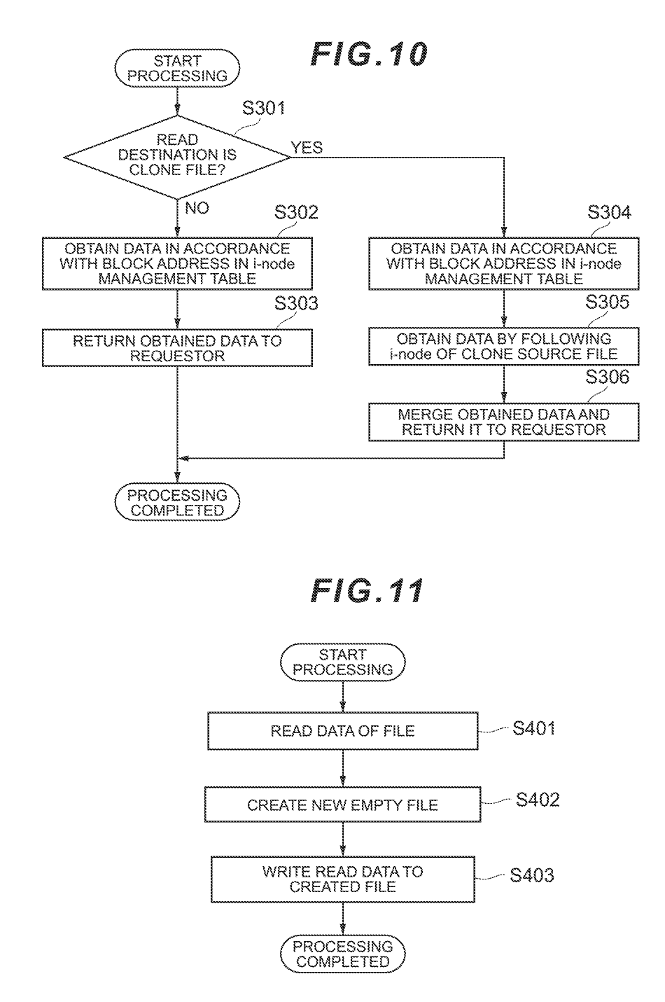

As depicted in FIG. 10, the file write program 113 judges whether a file read location is a clone file or not (S301). If it is determined in step S301 that the file read location is not a clone file, the file write program 113 obtains data in accordance with a block address in the i-node management table 500 (S302). Then, the file write program 113 returns the data obtained in step S302 to the client 300 who is the data requestor (S303).

On the other hand, if it is determined in step S301 that the file read location is a clone file, the file write program 113 obtains data in accordance with a block address in the i-node management table (S304). Furthermore, the file write program 113 obtains data by following the i-node of the clone source file (S305). Then, the file write program 113 merges the data obtained in step S304 with the data obtained in step S305 and returns the merged data to the client 300 who is the data requestor (S306).

### (5-4) File Copy Processing

As depicted in FIG. 11, the file copy program 114 firstly reads data of a copy target file (S401). Next, the file copy program 114 newly creates an empty file (S402). Then, the file copy program 114 writes the data read in step S401 to the file created in step S402 (S403).

The aforementioned read processing is executed when reading data of the file in step S401 and the aforementioned write processing is executed when writing the data in step S403. Then, the file copied by the file copy processing in FIG. 11 is single-instanced by the file deduplication processing which is executed periodically.

### (6) Advantageous Effects of this Embodiment

With the computer system according to this embodiment as described above, the current file size (the curr size) 504 and the file size at the time of cloning (the orig size) 505 are set to the i-node management table 500 managed by the file system 111 for the file storage system 100 (the file server). When the single instance of a file is executed by the deduplication processing, the file size at the time of execution of the single instance is set to the curr size and the orig size. Then, if a clone file having no data entity is updated by including appending of data, the data is appended to a clone source file and the file size after appending data is set to the curr size. Then, if the clone file to which the data is appended is copied, data of a copied file and the clone source file can be deduplicated and the copied file can be changed to a clone file. The file sizes and the data content of the relevant files need to be identical in order to execute the deduplication processing; however, the deduplication processing according to this embodiment can be executed if either the curr sizes or the orig sizes are identical. So, even if a clone file to which data is appended is copied, the data deduplication processing can be executed.

### (7) Other Embodiments

For example, each step of the processing by the file storage system 100 in this specification does not always have to be processed chronologically in the order described in the relevant flowchart. Specifically speaking, the respective steps in the processing by the file storage system 100 may be executed in parallel even though they are different processing.

Furthermore, it is possible to create computer programs for having hardware such as CPU's, ROM's, and RAM's contained in, for example, the file storage system 100 exhibit functions equivalent to those of each component of the above-described file storage system 100. Also, storage media in which the computer programs are stored are provided.

### REFERENCE SIGNS LIST

100 file storage system
111 file system
112 deduplication program
113 file write program
114 file copy program
115 logical path management program
116 kernel/driver
200 disk array apparatus
300 client

1. A file server coupled to a client terminal via a network, comprising:
a storage unit for storing received files; and
a control unit for controlling writing or reading of the files to or from the storage unit,
wherein the control unit:
performs deduplication by deciding one of files with the same content, which are stored in the storage unit, as a clone source file, and deciding another file as a clone file, which refers to data of the clone source file;
appends data to the clone source file in accordance with an update instruction for the clone file from the client terminal, and:
wherein when data of the clone file is updated in accordance with the update instruction, manages only difference data of the clone file in a case of an update not including appending of data, and appends data to the clone source file in a case of an update including additional writing of the data.

2. (canceled)

3. The file server according to claim 1, wherein when data of the clone file is to be updated in accordance with the update instruction and a size of update data included in the update instruction is larger than a file size of the clone file which is an update target, the control unit searches for the clone source file of the clone file and decides the clone source file to be the update target.

4. The file server according to claim 1, wherein the control unit sets a current file size of the file and a file size of the file when deduplicated to an i-node management table.

5. The file server according to claim 4, wherein when a file size of a deduplication target file matches either the current file size of the clone source file or the file size of the file when deduplicated, the control unit compares data of the deduplication target file with data of the clone source file.

6. The file server according to claim 5, wherein when the file size of the deduplication target file matches either the current file size of the clone source file or the file size of the file when deduplicated and the data of the deduplication target file matches the data of the clone source file, the control unit decides the deduplication target file to be a clone file, which refers to the data of the clone source file, and deletes the data of the deduplication target file.

7. A storage apparatus comprising the file server and a disk array apparatus controlled by the file server,
wherein the disk array apparatus includes a plurality of volumes formed into a drive group constituted from a plurality of physical drives;
wherein the file server stores files in the volumes; and
wherein the control unit:
performs deduplication by deciding one of files with the same content, which are stored in the storage unit, as a clone source file, and deciding another file as a clone file, which refers to data of the clone source file; and
appends data to the clone source file in accordance with an update instruction for the clone file from the client terminal, and
when data of the clone file is updated in accordance with the update instruction, manages only difference data of the clone file in a case of an update not including appending of data, and appends data to the clone source file in a case of an update including additional writing of the data

8. A data management method for a file server coupled to a
client terminal via a network,
the file server including a storage unit for storing received files and a control unit for controlling writing or reading of the files to or from the storage unit,
the data management method comprising:
a first step executed by the control unit performing deduplication by deciding one of files with the same content, which are stored in the storage unit, as a clone source file, and deciding another file as a clone file, which refers to data of the clone source file; and
a second step executed by the control unit appending data to the clone source file in accordance with an update instruction for the clone file from the client terminal,
wherein, in the second step, when data of the clone file is updated in accordance with the update instruction, the controller manages only difference data of the clone file in a case of an update not including appending of data, and appends data to the clone source file in a case of an update including additional writing of the data.
